(19) United States
(12) Patent Application Publication
(10) Pub. No.: US 2015/0304575 A1
(43) Pub. Date: Oct. 22, 2015

(54) Firefighters Integrated Thermal Imaging/ Information System

(71) Applicants: Eric Sacknoff, Rockville centre, NY (US); George T. Grammas, New Hyde Park, NY (US)

(72) Inventors: Eric Sacknoff, Rockville centre, NY (US); George T. Grammas, New Hyde Park, NY (US)

(21) Appl. No.: 14/686,753

(22) Filed: Apr. 14, 2015

Related U.S. Application Data
(60) Provisional application No. 61/980,885, filed on Apr. 17, 2014.

(51) Int. Cl. H04N 5/33; G02B 13/14; A42B 3/04; G02B 27/01

(52) U.S. Cl. CPC H04N 5/33; G02B 27/0172; G02B 13/14; A42B 3/042; G02B 27/0176; G02B 2027/014

(57) ABSTRACT

The invention is a small optical display connect to a facepiece. The optical display is paired via Bluetooth or WIFI to a thermal imager. This device will allow a firefighter to see the clearest picture possible through dense smoke. The integrated optical display may be paired with a smartphone, or similar informational device. Such a device may be utilized to display information to the firefighter, such as building plans or important messages. The integrated optical device shall be wholly independent of the facepiece and may easily be removed from one facepiece and placed in another.

### CROSS-REFERENCE TO RELATED APPLICATIONS

This is a non-provisional of provisional application 61/980,885 filed on Apr. 17, 2014.

### STATEMENT AS TO RIGHTS TO INVENTIONS UNDER FEDERALLY SPONSORED RESEARCH AND DEVELOPMENT

None

### FIELD OF THE INVENTION

This device refers to the field of Integrated Thermal Imaging/Information System and more specifically having it being used in firefighting/first response.

### BACKGROUND OF THE INVENTION

Firefighters are on the front line of public safety and need the best tools possible. Firefighters routinely work in smoke filled environments where vision is compromised.

Thermal imaging cameras use special filters and sensors to interpret infrared rays and produce an image. This critical capability enables firefighter to ‘see’ in a smoke filled environment.

In the current art, thermal imagers designed for firefighter use are handheld models, other iterations of the tool have been presented—helmet mounted, hanging lanyard attachment, crawling, etc. The NFPA (National Fire Protection Association) Standard 1801 establishes a basic foundation of design and features for all certified fire fighting thermal imaging cameras.

Today's occupancies have more manmade materials than ever before—especially petroleum based products. These manmade materials produce a heavier, denser smoke. One problem for firefighters is that this dense smoke creates a barrier to the use of thermal imaging cameras. The optimum viewing distance from the eyes to the display screen of the thermal imager is about 18 inches. Thick, dense smoke can fill this space to such a degree that the image cannot be seen. Firefighters have reported environments of such dense smoke as to deny the firefighter the ability to see the displayed thermal image, even with the camera held close to the firefighter's facepiece.

There remains room for improvement in the current art.

### SUMMARY OF THE INVENTION

The current invention is relates to an Integrated Thermal Imaging/Information System for firefighters or other first responders. Firefighters routinely work in smoke filled environments where vision is compromised. Thermal imaging cameras use special filters and sensors to interpret infrared rays and produce an image. This critical capability enables firefighter to ‘see’ in a smoke filled environment.

The purpose of this invention is to allow firefighters to see in a smoke filled environment.

Usually the firefighter will be wearing a SCBA (self contained breathing apparatus) with a facepiece. Self-Contained-Breathing-Apparatus have been used for a number of years by Firefighters, First Responders and personnel dealing with bio or chemical hazards.

The current invention has a small optical display integrated within the firefighter's facepiece. This optical display is paired via Bluetooth or WIFI to a handheld thermal imager. Such a device will assure the firefighter sees the clearest picture possible through dense smoke.

In another iteration of this invention, the integrated optical display may be paired with a smartphone, or similar informational device. Such a device may be utilized to display information to the firefighter, such as building plans or important messages.

The integrated optical device shall be wholly independent of the facepiece and may Easily be removed from one facepiece and placed in another.

### BRIEF DESCRIPTION OF DRAWINGS

Without restricting the full scope of this invention, the preferred form of this invention is illustrated in the following drawings in which:

FIG. 1 is a view of a standard Self-Contained-Breathing-Apparatus (SCBA);

FIG. 2 is a view of the main components of the invention;

FIG. 3 is a view of the optical display within the facepiece;

FIG. 4 shows the integrated optical device being moved from one facepiece to another;

FIG. 5 shows the device with a wireless system.

### DETAILED DESCRIPTION OF THE PREFERRED EMBODIMENT

There are a number of significant design features and improvements incorporated within the invention.

This invention is a Integrated Thermal Imaging/Information System for firefighters or other first responders. The purpose of this invention is to allow a user such as a firefighter or first responder to ‘see’ in a smoke filled environment.

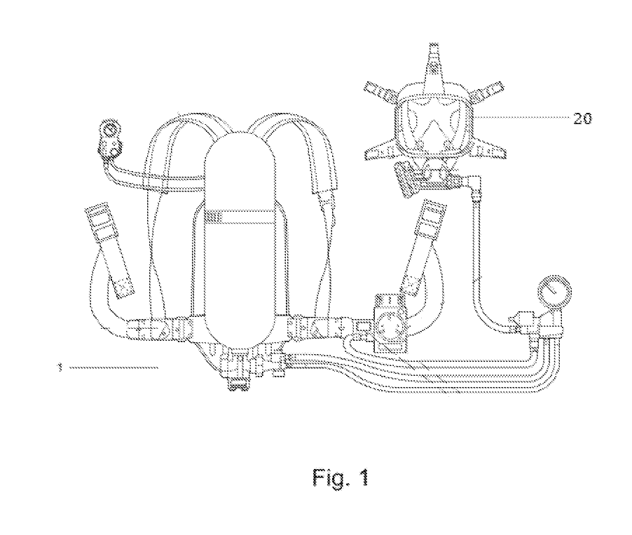

Usually a firefighter will be wearing a SCBA (self contained breathing apparatus) 1 with a facepiece 20 and helmet 25 as shown in FIG. 1. Self-Contained-Breathing-Apparatus 1 have been used for a number of years by Firefighters, First Responders and personnel dealing with bio or chemical hazards.

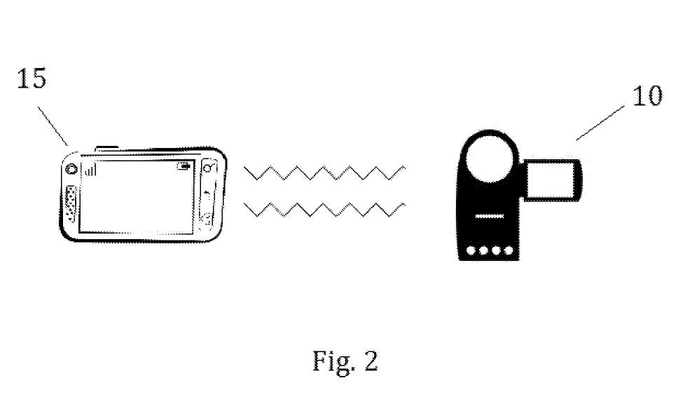

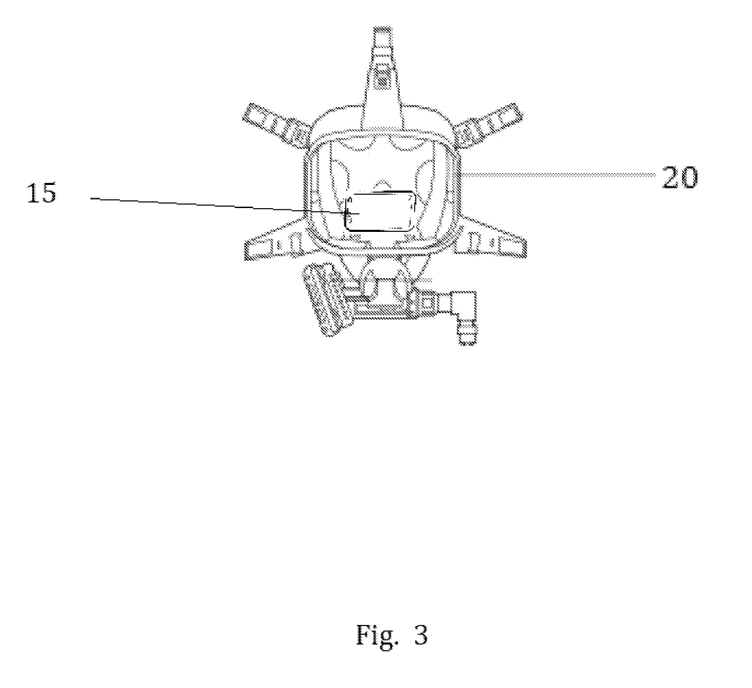

As shown in FIG. 2, the invention has two main components, a thermal imager 10 and an optical display 15. FIG. 3 shows the optical display 15 positioned inside the facepiece 20 where the user can best see it while not obstructing their vision or interfering with their “line of sight”.

The optical display 15 in current invention is a small optical display 15 so that it fits within the facepiece 20. This optical display 15 is integrated within the firefighter's facepiece 20. The optical display 15 is paired via radio frequency, Bluetooth, Zigby, near-field , WIFI or any other transmitting means to a handheld or mounted thermal imager 10. The optical display 15 will display the images received from the thermal imager 10. This device will assure the firefighter sees the clearest picture possible through dense smoke.

The thermal imager 10 is a standard thermal imager. Thermal imaging cameras use special filters and sensors to interpret infrared rays and produce an image. In the preferred embodiment it is a hand held device but it can also be designed to be used either as a hand held device or it can be mounted on a mount on the users helmet 25 or other location. This will allow the user to point the thermal imager 10 where the user needs to see or mounted so it is pointing where the user needs to be looking at. It can even be placed in a stationary location allowing the flexibility to see an effected area that may be too dangerous to them to stay in.

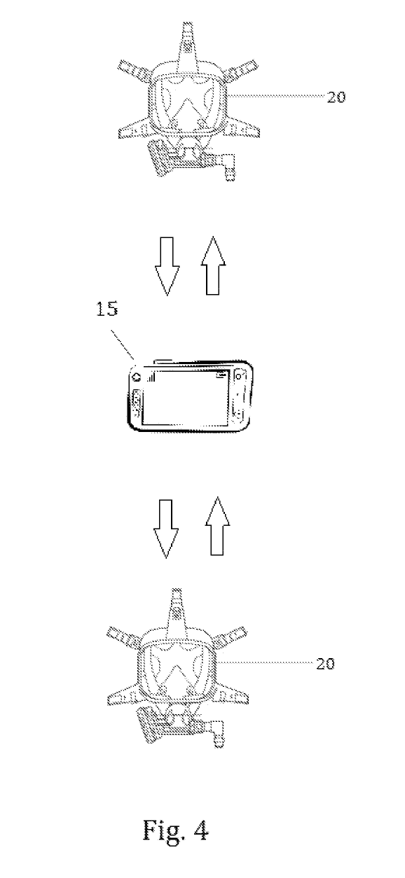

In the preferred embodiment, the integrated optical device 15 is wholly independent of the facepiece 20 and may easily be removed from one facepiece 20 and placed in another as shown in FIG. 4. In an alternative embodiment it is permanently attached or integrated into the facepiece 20.

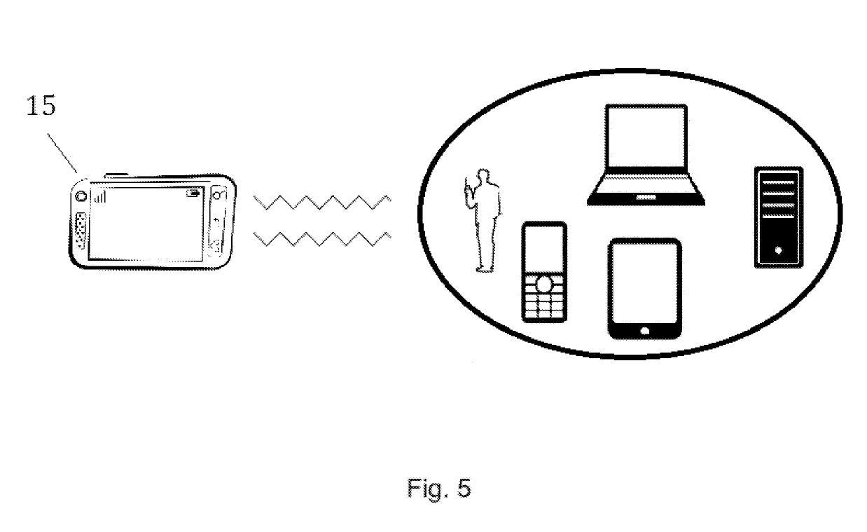

In another iteration of this invention, the integrated optical display may be paired with a smartphone, tablet, personal computer, server or similar informational device. Such a device may be utilized to display information to the firefighter, such as building plans or important messages. It can be connected to a command center. This is shown in FIG. 5.

Gas detectors, physiological monitors, smartphones or any other device can be used to transmit data to the optical display 15. Multiple devices can be connected to the optical display 15 at the same time allowing the display of the data from these multiple sources. The user can activate or deactivate the devices being displayed manually or wirelessly. This can also be controlled by a third party such as a command center.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur by those skilled in the art, it is not desired to limit the invention to the exact construction and operation shown and described, and accordingly, all suitable modifications and equivalents may be resorted to, falling within the scope of the invention.

I claim:

1. A device comprising:
an optical display that receives and displays images wirelessly from a thermal imager where the optical display is connected to a facepiece.

2. A device according to claim 1 where the optical display is removable.

3. A device according to claim 1 where the optical display receives the images wirelessly.

4. A device according to claim 3 where the wireless can be one or more of the following WIFI, Bluetooth, Zigby, near-field or any other wireless mechanism.

5. A device according to claim 1 where the thermal imager is handheld.

6. A device according to claim 1 where the thermal imager is mounted.

7. A device according to claim 1 where the thermal imager is mounted on the helmet.

8. A device according to claim 1 where the optical display can receive information from one or more other devices.

9. A device according to claim 1 where the optical display is integrated into a facepiece.

10. A device according to claim 1 where the facepiece has a wirelessly receiving and optically displaying device integrated into the inside of the facepiece and the facepiece is part of a Self Contained Breathing Apparatus (SCBA).

11. A device as described in claim 10 whereby the optical device can be permanently or remove-ably mounted to the inside of the facepiece.

12. A device as described in claim 10 whereby the device can be physically placed within the facepiece at variable locations.

13. A device as described in claim 10 whereby the optical device is self-powered, preferably by a portable battery.

14. A device as described in claim 10 whereby the optical device can receive and display images and/or data.

15. A device as described in claim 14 whereby the mechanism of transmission can be via radio frequency, Bluetooth, Zigby, near-field or any other wireless mechanism.

16. A device as described in claim 14 whereby images and/or data can be transmitted from one of more of such devices as Thermal Imagers, Gas detectors, Physiological monitors, smartphones or any other device capable of transmitting images and/or data

17. A device as described in claim 16 whereby such transmitting devices can be handheld or worn or attached to the user

18. A device as described in claim 10 whereby such device can be activated and/or deactivated either via manual means and/or wirelessly.

19. A device as described in claim 10 whereby the device is physically mounted at a distance from the user's eye so as to provide an optimal field of view when looked at.
